(19) United States
(12) Patent Application Publication
(10) Pub. No.: US 2020/0163814 A1
(43) Pub. Date: May 28, 2020

(54) Method for Providing Control Signals for at least Partly Automated Driving of a Vehicle into a Stopping Position

(71) Applicant: Robert Bosch GmbH, Stuttgart (DE)

(72) Inventors: Christoph Gustav Keller, Stuttgart (DE); Holger Mielenz, Ostfildern (DE)

(21) Appl. No.: 16/659,700

(22) Filed: Oct. 22, 2019

(30) Foreign Application Priority Data
Nov. 27, 2018 (DE) 10 2018 130 018.2

(51) Int. Cl. A61G 3/02; B60W 40/02; A61G 3/08

(52) U.S. Cl. CPC A61G 3/0209; B60W 40/02; B60W 2300/38; B60W 2520/04; A61G 3/0808

(57) ABSTRACT

The disclosure relates to a a method for automating driving of a vehicle into a stopping position. The method includes receiving and processing vehicle environment signals, and generating control signals configured to at least partly automate the driving of the vehicle into the stopping position. The processing includes detecting an entry/exit area to be used for boarding/disembarking of a wheelchair user, checking whether the entry/exit area has spatial dimensions required for for the boarding/disembarking, checking whether the entry/exit area is independently traversable by the wheelchair user, and determining a stopping position adjacent to the entry/exit area for stopping the vehicle in response to recognizing that (i) the entry/exit area has the spatial dimensions required for the at least one of the boarding and the disembarking of the wheelchair user and (ii) the entry/exit area is independently traversable by the wheelchair user.

This application claims priority under 35 U.S.C. § 119 to application no. DE 10 2018 130 018.2, filed on Nov. 27, 2018 in Germany, the disclosure of which is incorporated herein by reference in its entirety.

### TECHNICAL FIELD

The disclosure relates to a method for providing control signals for at least partly automated driving of a vehicle into a stopping position. The disclosure further relates to a device that is set up to carry out the method for providing control signals for at least partly automated driving of a vehicle into a stopping position. The disclosure also relates to a vehicle with the device. The disclosure also relates to a computer program. The disclosure additionally relates to a machine-readable storage medium.

### BACKGROUND

Methods for the automated driving of a vehicle into a stopping position, in particular a parking position, are known. These methods usually provide for a vehicle to be driven at least partly automatically into a stopping position that is recognized by the vehicle and/or the driver. Furthermore, a sensor device is known from document DE 10 2012 204 386 A1 that indicates to a driver of a vehicle, after he has selected a potential stopping position, whether this stopping position provides sufficient space on both sides of the vehicle, so that the occupants of the vehicle, such as a wheelchair user, are able to board/disembark.

### SUMMARY

The object underlying the disclosure can be seen in finding an efficient method for providing control signals for at least partly automated driving of a vehicle into a stopping position, which facilitates a wheelchair user to board/disembark.

The object is achieved by means of the respective subject matter of the disclosure. Advantageous embodiments are also the subject matter of the disclosure.

According to one aspect of the disclosure, a method for providing control signals for at least partly automated driving of a vehicle into a stopping position is provided, including the following steps of the method: receiving environment signals of the vehicle, processing the environment signals, to: a) detect an entry/exit area for boarding and/or disembarking a wheelchair user, b) check whether the entry/exit area has the spatial dimensions required for the boarding/disembarking of a wheelchair user, c) recognize that the entry/exit area has spatial dimensions required for the boarding/disembarking of a wheelchair user, d) check whether the wheelchair user can traverse the entry/exit area independently, e) recognize that the wheelchair user can traverse the entry/exit area 2 0 independently, f) determine a stopping position adjacent to the entry/exit area to stop the vehicle when steps c) and e) of the method are carried out, and generate control signals for at least partly automated driving of the vehicle into the stopping position.

According to a second aspect, a device is provided that is set up to perform all the steps of a method for providing control signals for at least partly automated driving of a vehicle into a stopping position.

According to a third aspect, a vehicle is provided that comprises the described device.

According to a fourth aspect, a computer program is provided including instructions that, when the computer program is executed by a computer or a control device of the vehicle, cause the program to carry out the method for providing control signals for at least partly automated driving of a vehicle into a stopping position.

According to a fifth aspect, a machine-readable storage medium is provided on which the described computer program is stored.

The disclosure is based on the realization that the above object can be achieved by the fact that based on environment signals representing at least a part of the vehicle's environment, a stopping position is selected for stopping the vehicle with an entry/exit area of spatial dimensions required for a wheelchair user to board/disembark and which a wheelchair user can traverse independently.

This, for example, gives the technical advantage that the spatial dimensions and the traversability for a wheelchair user of an entry/exit area of a stopping position can be taken into account as selection criteria for a suitable stopping position. The entry/exit area must therefore allow both the boarding/disembarking and the independent movement of a wheelchair user to and/or away from the vehicle. If a potential stopping position does not have such an entry/exit area, the respective stopping position will be discarded and a further stopping position will be sought.

Thus, the technical advantage is achieved that a method for providing control signals for the at least partly automated driving of a vehicle into a stopping position is provided that allows a wheelchair user to board/disembark independently and that can be independently traversed by a wheelchair user, so that the wheelchair user can move independently towards and/or away from the vehicle.

The phrase “at least partly automated driving” includes the following cases: partly automated control or driving, highly automated control or driving, fully automated control or driving, driverless control or driving.

Partially automated control or driving means that in a specific use case (for example: driving on a highway, driving inside a parking lot, overtaking an object, driving within a lane defined by lane markings) longitudinal and lateral guidance of the vehicle are controlled automatically. A driver of the vehicle does not have to manually control the longitudinal and lateral guidance of the vehicle. However, the driver must continuously monitor the automatic control of the longitudinal and lateral guidance of the vehicle in order to be able to intervene manually if necessary.

Highly automated control or driving means that in a specific use case (for example: driving on a highway, driving inside a parking lot, overtaking an object, driving within a lane defined by lane markings) longitudinal and lateral guidance of the vehicle are automatically controlled. A driver of the vehicle does not have to manually control the longitudinal and lateral guidance of the vehicle. The driver does not have to continuously monitor the longitudinal and lateral guidance of the vehicle monitor in order to be able to intervene manually if necessary. If necessary, a takeover request is automatically issued to the driver for the control of the longitudinal and lateral guidance. The driver must therefore potentially be able to control the longitudinal and lateral guidance.

Fully automated control or driving means that in a specific use case (for example: driving on a motorway, driving inside a parking lot, overtaking an object, driving within a lane defined by lane markings) longitudinal and lateral guidance of the vehicle are controlled automatically. A driver of the vehicle does not have to manually control the longitudinal and lateral guidance of the vehicle. The driver does not have to monitor the automatic control of the longitudinal and lateral guidance of the vehicle in order to be able to intervene manually if necessary. In the specific use case the driver is not required.

Driverless control or driving means that regardless of a specific use case (for example: driving on a highway, driving inside a parking lot, overtaking an object, driving within a lane defined by lane markings) longitudinal and lateral guidance of the vehicle can be controlled automatically. A driver of the vehicle does not have to manually control the longitudinal and lateral guidance of the vehicle. The driver does not have to monitor the automatic control of the longitudinal and lateral guidance of the vehicle in order to be able to intervene manually if necessary. The longitudinal and lateral guidance of the vehicle are thus controlled automatically, for example, on all types of road, in all speed ranges and environmental conditions. The driver's entire driving task is thus taken over automatically. The driver is therefore no longer required. The vehicle can therefore drive from any starting position to any destination without a driver. Potential problems are solved automatically.

In the present context, a stopping position may be a position at which the vehicle can be brought to a complete standstill for at least a period of time required for a passenger's boarding/disembarking procedure.

The stopping position may be a temporary stopping position, in particular a stopping position on the edge of the roadway that is used exclusively for loading and/or unloading of the vehicle. The stopping position can also be an explicitly excellent parking position, in particular a parallel and/or lateral parking space, in which the vehicle can be parked for a longer period of time.

The entry/exit area of a stopping position can be directly adjacent to the area of the stopping position and may be oriented both laterally and parallel to the stopping position. This may ensure that a wheelchair user can board/disembark or that a wheelchair can be loaded both at the side of the vehicle and at the rear of the vehicle.

The spatial dimensions of the entry/exit area may include horizontal components, which can be used to determine a ground area of the entry/exit area. The ground area may include a minimum width and a minimum length, which the ground area must meet in order to allow a wheelchair user to board/disembark.

Furthermore, the spatial dimensions of the entry/exit area may include a vertical component which can be used to define a minimum height of the entry/exit area that is necessary for boarding/disembarking or for loading a wheelchair user by means of a loading device that is fitted to the vehicle.

According to one embodiment, the control signals for at least partly automated driving of the vehicle into the stopping position also include stopping the vehicle in the stopping position.

This achieves the technical advantage of an efficient method of stopping the vehicle in the stopping position.

According to one embodiment, the method also includes the steps: g) detecting a path section leading away from the entry/exit area and/or leading to the entry/exit area, h) checking whether the path section can be traversed independently by the wheelchair user i) recognizing that the path section can be traversed independently by the wheelchair user, wherein the step f) of the method is carried out if at least the steps c) and (e) and i) of the method are carried out.

This means that the technical advantage is achieved that the presence of a path section connected to the entry/exit area that allows the wheelchair user to move away from the vehicle or move towards it can be taken into account as a further criterion for selecting a suitable stopping position. This allows the wheelchair user to continue his or her way to the destination independently after disembarking from the vehicle. In addition, the wheelchair user can proceed to the vehicle independently in order to start the journey with the vehicle.

According to one embodiment, the step d) of the method also includes the steps: j) detecting an object within the entry/exit area, k) checking whether the object is an obstacle that prevents the wheelchair user from using the wheelchair for traversing the entry/exit area independently.

This provides the technical advantage of a precise assessment of the traversability of the entry/exit area for the wheelchair user. Thus, the presence of obstacles can be used as a further selection criterion for the choice of a suitable stopping position. Thus, it is possible to avoid selecting a stopping position with an entry/exit area which allows a wheelchair user to disembark, but from which the wheelchair user cannot move away independently due to the obstacle, or to which the wheelchair user has no access because of the obstacle.

According to one embodiment, an obstacle for a wheelchair user is an object from the list including a stair step, a curb, a railway track, a barrier, a wall, a fence, a flower pot, a hydrant, a rubbish bin, a movable object, in particular a vehicle, and/or comparable objects and/or a combination of the mentioned objects.

This allows the technical advantage to be achieved that an object can be precisely determined as an obstacle for a wheelchair user.

According to one embodiment, the step d) of the method also includes the steps: l) detecting a ground area of the entry/exit area, m) determining an inclination of the ground surface, n) checking whether the ground area is suitable for use by a wheelchair user on the basis of the inclination.

This in turn provides the technical advantage of a precise assessment of the traversability of the entry/exit area by the wheelchair user. Thus, the slope of the ground area of the entry/exit area results in a further exclusion criterion for the choice of an appropriate stopping position. A potential stopping position with an entry/exit area whose ground area has an inclination that exceeds a predetermined limit value is dropped as a stopping position.

According to one embodiment, the step d) of the method also comprises the steps: o) detecting a ground area of the entry/exit area, p) determining a ground covering of the ground surface, q) checking whether the ground area is suitable for use by a wheelchair user on the basis of the ground covering.

This in turn provides the technical advantage of a precise assessment of the traversability of the entry/exit area for the wheelchair user. Thus, the ground covering of the ground area of the entry/exit area results in a further exclusion criterion for the choice of a suitable stopping position. A potential stopping position with an entry/exit area, the ground area of which comprises a ground covering that is considered unsuitable for independent traversal by a wheelchair user, is dropped as a stopping position.

According to one embodiment, a ground covering includes a concrete surface, an asphalted road surface, a cobblestone surface, a paved surface, a forest path, a gravel path, a wet layer, a layer of snow, a mud layer, a layer of foliage, a layer of sand and/or a comparable ground covering and/or a combination of the aforementioned ground coverings. This gives the technical advantage that a precise determination of a ground covering of a ground area of an entry/exit area is possible.

According to one embodiment, data from a database, in particular a digital map, are taken into account for at least one of the steps a) to (q) of the method.

This achieves the technical advantage of efficiently taking into account information from a database. This also achieves the technical advantage that more suitable stopping positions can be determined and/or suitable stopping positions can be determined more quickly.

According to one embodiment, a stopping position in a specified target area is determined based on the data of the database.

This achieves the technical advantage that, on the basis of the data stored in a corresponding database, a pre-selection of potential stopping positions, in particular excellent parking facilities with suitable entry/exit areas with the characteristics described above, can be carried out by the vehicle at the time of setting off or while travelling. This information can then be incorporated into route planning from the current location and/or from the location at the time of setting off towards the destination, so that faster, more effective and more cost-effective transport can be guaranteed.

According to one embodiment, environment signals include environment sensor data of one or more vehicle environment sensors.

For example, an environment sensor is one of the following environment sensors: radar sensor, lidar sensor, ultrasonic sensor, infrared sensor, magnetic field sensor and video sensor.

According to one embodiment, it is provided that the vehicle is set up or embodied according to the third aspect to carry out or perform the described method.

According to one embodiment, it is provided that the method is carried out or performed to provide control signals for at least partly automated driving of a vehicle into a stopping position by means of the described device and/or by means of the described vehicle.

Features of the device result similarly from corresponding features of the method and vice versa. This means, in particular, that technical functionalities of the method according to the first aspect are based on corresponding technical functionalities of the device in accordance with the second aspect.

This means in particular that further embodiments of the device according to the second aspect similarly result from corresponding embodiments of the method according to the first aspect.

### BRIEF DESCRIPTION OF THE DRAWINGS

The disclosure is explained in more detail below on the basis of preferred embodiments. In the figures:

FIG. 1 shows a flow chart of a method for providing control signals for at least partly automated driving of a vehicle into a stopping position according to a first embodiment;

FIG. 2 shows a schematic representation of a practical implementation of the method of FIG. 1;

FIG. 3 shows a flow chart of the method for providing control signals for at least partly automated driving of a vehicle into a stopping position according to a further embodiment;

FIG. 4 shows a flow chart of the method for providing signals for at least partly automated driving of a vehicle into a stopping position according to a further embodiment;

FIG. 5 shows a flow chart of the method for providing control signals for at least partly automated driving of a vehicle into a stopping position according to a further embodiment;

FIG. 6 shows a flow chart of the method for providing control signals for at least partly automated driving of a vehicle into a stopping position according to a further embodiment;

FIG. 7 shows a device for carrying out the method for providing control signals for at least partly automated driving of a vehicle into a stopping position;

FIG. 8 shows a vehicle; and

FIG. 9a shows machine-readable storage medium.

### DETAILED DESCRIPTION

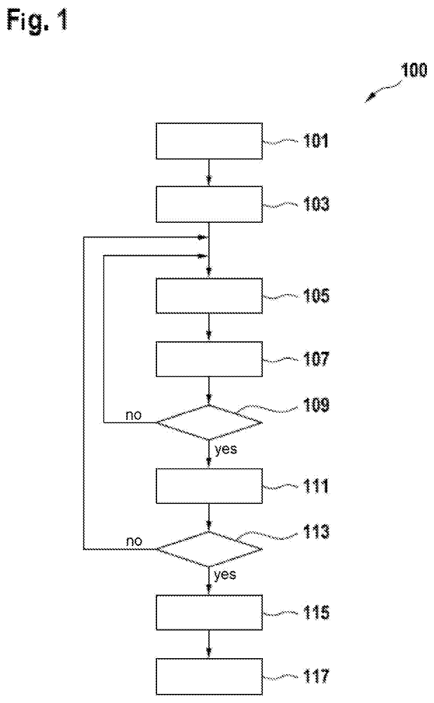

FIG. 1 shows a method 100 for providing control signals for at least partly automated driving of a vehicle into a stopping position, including the following steps of the method:

Receiving 101 environment signals of the vehicle;

Processing 103 the environment signals, to:

a) Detect 105 an entry/exit area for boarding and/or disembarking by a wheelchair user;

b) Checking 107 whether the entry/exit area has spatial dimensions that are required for the boarding/disembarking of a wheelchair user;

c) Recognizing 109 that the entry/exit area has spatial dimensions that are required for the boarding/disembarking of a wheelchair user;

d) Checking 111 whether the entry/exit area can be independently traversed by the wheelchair user;

e) Recognizing 113 that the entry/exit area can be independently traversed by the wheelchair user;

f) Determining 115 a stopping position adjacent to the entry/exit area for stopping the vehicle; and

Generating 117 control signals for at least partly automated driving of the vehicle into the stopping position.

In a first step 101 of the method, environment signals of the vehicle are received by the vehicle, in particular by an appropriately set up device of the vehicle.

Environment signals can be signals from an environment sensor of the vehicle and represent at least one sub environment of the vehicle.

In a following step 103 of the method, the received environment signals are processed by the device, in particular by a processor of the device that is set up for this purpose.

Based on the processed environment signals, the processor detects an entry/exit area for boarding and/or disembarking by a wheelchair user in a further step 105 of the method.

For this purpose, corresponding features, which must include an entry/exit area for the boarding/disembarking of a wheelchair user, may be implemented in a database or in the processor or in a computer program. For the detection of an entry/exit area, the processor can determine the characteristics of a detected area and compare these with the stored characteristics of an entry/exit area in order to determine whether the detected area has the characteristics of an entry/exit area.

If the processor does not detect an entry/exit area in step 105 of the method, the processor continues the search for an entry/exit area and a suitable stopping position. For this purpose, the processor can drive the vehicle to a further entry/exit area by generating and issuing to an appropriate control device of the vehicle appropriate control signals in order to receive new environment signals. For example, the processor can also cause the further reception of further environment signals by further actuation of the corresponding environment sensors. For example, the processor can also re-evaluate already received environment signals in order to detect a further entry/exit area.

If the processor detects an entry/exit area in step 105 of the method, in a following step 107 of the method the processor checks whether the entry/exit area has spatial dimensions required for the boarding/disembarking of a wheelchair user.

For this purpose, corresponding limit values for the spatial dimensions of an entry/exit area, which must have an entry/exit area for the boarding/disembarking of a wheelchair user, may be implemented in a database or in the processor or in a computer program. To assess the spatial dimensions of an entry/exit area, the processor can determine the spatial dimensions of a detected entry/exit area and compare the dimensions with the stored values.

For example, an entry/exit area with a footprint of less than 180×180 cm2 can be considered too small for an entry/exit area.

If the processor assesses the spatial dimensions of a detected entry/exit area as insufficient in step 107 of the method, in a subsequent step 109 of the method the processor recognizes that the entry/exit area has no spatial dimensions that are relevant for the boarding/disembarking of a wheelchair user. Subsequently, the processor rejects the entry/exit area and the respective stopping position as unsuitable and continues the procedure with step 105 of the method, in that the processor searches for a further entry/exit area. For this purpose, the processor may drive the vehicle to a further entry/exit area by generating and issuing suitable control signals to a corresponding control device of the vehicle in order to receive new environment signals. For example, the processor can also cause a further recording of further environment signals by a further actuation of the corresponding environment sensors. For example, the processor can also re-evaluate already received environment signals in order to detect a further entry/exit area.

If the processor assesses the spatial dimensions of a detected entry/exit area as sufficient in step 107 of the method, in the following step 109 of the method the processor recognizes that the entry/exit area has spatial dimensions that are required for the boarding/disembarkation of a wheelchair user.

Subsequently, in a further step 111 of the method the processor checks whether the entry/exit area can be independently traversed by a wheelchair user.

For this purpose, corresponding limits for various characteristics of an entry/exit area related to the traversability of an entry/exit area may be implemented in a database or in the processor or in a computer program. In order to assess the traversability of a detected entry/exit area, the processor can determine the corresponding properties of the detected entry/exit area and compare them with the stored limit values.

For example, an entry/exit area can be rated as not independently traversable by a wheelchair user if the entry/exit area is either not traversable at all or the wheelchair user needs help to move around.

If the check according to step 111 of the method shows that a wheelchair user cannot traverse the entry/exit area independently, in a subsequent step 113 of the method the processor detects that the entry/exit area is not independently traversable by wheelchair users. Subsequently, the processor discards the entry/exit area and the respective stopping position and continues the procedure with step 105 of the method, in that the processor seeks a further entry/exit area. For this purpose, the processor can drive the vehicle to a further entry/exit area by generating and issuing to a corresponding control device suitable control signals in order to receive new environment signals. For example, the processor can also cause a further recording of further environment signals by a further actuation of the corresponding environment sensors. For example, the processor can also re-evaluate already received environment signals to detect a further entry/exit area.

If the check after step 111 of the method shows that the entry/exit area can be traversed independently by a wheelchair user, in a following step 113 of the method the processor detects that the entry/exit area can be traversed by a wheelchair user.

Subsequently, in a subsequent step 115 of the method the processor determines a stopping position that is adjacent to the entry/exit area recognized as suitable according to steps 109 and 113 of the method as a stopping position for stopping the vehicle.

After determining the stopping position according to step 115 of the method, in a subsequent step 117 of the method the processor generates control signals for at least partly automated driving of the vehicle into the stopping position in order to drive the vehicle into the stopping position at least partly automatically.

The control signals generated by the processor according to step 117 of the method for at least partly automated driving of the vehicle into the stopping position may also include stopping the vehicle in the stopping position.

In the embodiment of the method 100 shown in FIG. 1, step 107 of the method to check whether the entry/exit area has the required spatial dimensions is carried out by the processor before step 111 of the method to check whether the entry/exit area can be independently traversed by a wheelchair user. However, the disclosure should not be limited to this. Rather, the processor can perform steps 107 and 111 of the method in any chronological sequence, wherein a negative result of one of the steps 107 and 111 of the method automatically results in cancellation of the checking process and in continuation of the method 100 with step 105 of the method in that the processor continues to seek a suitable entry/exit area.

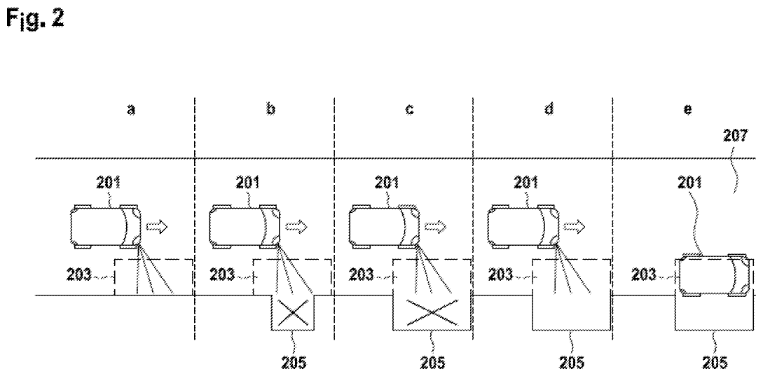

FIG. 2 shows a schematic representation of a practical implementation of the method 100 for providing control signals for at least partly automated driving of a vehicle 201 into a stopping position 203 in FIG. 1.

The basic functions of the method 100 for providing control signals for at least partly automated driving of a vehicle 201 into a stopping position 203 according to the first embodiment are described below based on FIG. 2.

In section a) of FIG. 2, a vehicle 201 is shown first that is at least partly automatically controlled by a processor and a control device to move on a roadway 207 that is provided for this purpose. With a device set up for this purpose, for example an environment sensor, the vehicle 201 senses the environment to generate environment signals that represent at least a partial environment of the vehicle 201 in order to detect a stopping position 203 with an entry/exit area based on the environment signals by means of a processor.

Section (a) shows the case in which although a stopping position 203 for stopping the vehicle 201 is detected by the processor of the vehicle 201, the stopping position 203 does not have an entry/exit area. If the processor of the vehicle does detect an entry/exit area 205, the method 100 provides that further stopping positions 203 will be sought by the processor until an exit area 205 is detected. For this purpose, the processor can continue to move the vehicle along the roadway 207 to a further stopping position 203 by generating and issuing suitable control signals to a corresponding control device of the vehicle. For example, the processor can receive further environment signals by means of the environment sensors of the vehicle. For example, the processor can also reprocess already received environment signals to detect a further entry/exit area.

Section b) shows the case in which the vehicle 201 has driven to a further stopping position and the processor of the vehicle 201 has detected an entry/exit area 205 for the boarding/disembarking of a wheelchair user. According to step 107 of the method 100, on detecting an entry/exit area 205 the processor checks whether the detected entry/exit area 205 has spatial dimensions that are necessary for boarding/disembarking a wheelchair user into or out of the vehicle 201.

In section b), the detected entry/exit area 205 does not have such spatial dimensions that allow a wheelchair user to board/disembark. In such a case, the method 100 provides that the processor assesses the entry/exit area 205 as unsuitable and rejects the corresponding stopping position 203 as a potential stopping position 203. Furthermore, the method 100 provides that the processor of the vehicle 201 subsequently continues to search for a stopping position 203 with a suitable entry/exit area 205. For this purpose, the processor can drive the vehicle along the roadway to a further stopping position 203 by generating and issuing suitable control signals to an appropriate control device of the vehicle. For example, the processor may also receive further environment signals by means of the environment sensors of the vehicle. For example, the processor may also re-process already received environment signals in order to detect a further entry/exit area.

For example, an entry/exit area with a footprint of less than 180×180 cm2 may be considered too small for an entry/exit area.

In section c), the case is shown in which the vehicle has again driven to a further stopping position in the search for a suitable entry/exit area and the processor of the vehicle 201 detects a stopping position 203 with an entry/exit area 205. Furthermore, the processor of the vehicle 201 recognizes that the detected entry/exit area 205 has sufficient space for the boarding/disembarking of a wheelchair user. However, the check by the processor according to step 111 of the method has shown that the detected entry/exit area 205 cannot be independently traversed by a wheelchair user. The method 100 provides for such a case that the processor also assesses this entry/exit area 205 as unsuitable and discards the corresponding stopping position 203 as a possible stopping position. The method 100 will, however, continue with step 105 of the method in that the processor of the vehicle 201 continues the search for a stopping position 203 with a suitable entry/exit area 205.

Step 107 of the method for checking the spatial dimensions of an entry/exit area 205 and step 111 of the method for checking whether the respective entry/exit area 205 can be independently traversed by a wheelchair user can be carried out by the processor in any chronological order and a negative result already leads towards the immediate termination of all the checking steps.

Section d) shows the case in which the vehicle has again driven to a further stopping position and the processor of the vehicle 201 detects a stopping position 203 with an entry/exit area 205 that has suitable spatial dimensions and that can be independently traversed by a wheelchair user. For such an entry/exit area 205, the processor detects, in accordance with steps 109 and 113 of the method, that the entry/exit area 205 has suitable spatial dimensions and that it can be independently traversed by a wheelchair user, and determines according to step 115 of the method that the stopping position 203 adjacent to the entry/exit area 205 is a suitable stopping position 203 for stopping the vehicle 201.

Section e) shows the conclusion of the method 100. After the processor has recognized the entry/exit area 205 as suitable according to steps 109 and 113 of the method and has determined the corresponding stopping position from section d) as a suitable stopping position according to step 115 of the method, the processor of the vehicle 201 issues control signals in accordance with step 117 of the method in order to drive the vehicle to the specified stopping position 203 and to make the vehicle 201 stop there, so that the vehicle 201 drives into the stopping position 205 and stops there.

In FIG. 2 the stopping position 203 is shown as a stopping position 203 oriented along the edge of the roadway. However, the stopping position can also be a lateral parking gap, or a longitudinal parking gap defined by barriers and as such explicitly excellent. The stopping position 203 can also be a stopping position or a parking space in a suitable car park or in a parking garage.

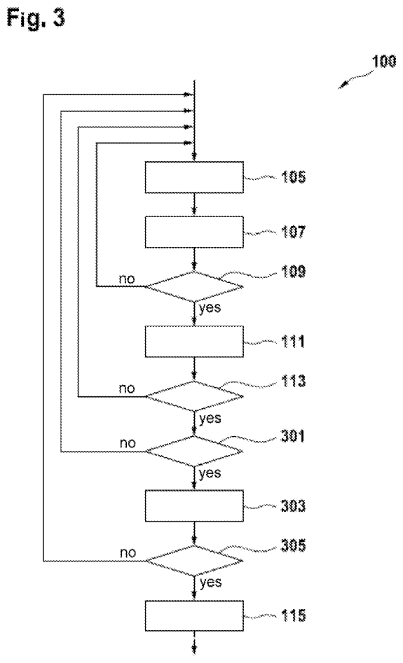

FIG. 3 shows a flow chart of the method 100 for providing control signals for at least partly automated driving of a vehicle into a stopping position according to a further embodiment.

Steps 101, 103 and 117 of the method 100 in FIG. 1 are not explicitly represented in FIG. 3.

In addition to the steps of the method shown in FIG. 1, the method 100 according to a further embodiment in FIG. 3 includes the steps:

g) Detecting 301 a path section leading away from the entry/exit area and/or leading towards the entry/exit area;

h) Checking 303 whether the path section is independently traversable by the wheelchair user;

i) Recognizing 305 that the path section is independently traversable by the wheelchair user.

After the processor has detected an entry/exit area in accordance with steps 101, 103, 105, 107, 109 and 111 of the method and has recognized that it has the appropriate spatial dimensions as well as being able to be traversed independently by a wheelchair user, the processor detects a path section according to step 301 of the method that leads away from and/or leads towards the entry/exit area. Such a path section may be a section of a walkway, a cycle path, a roadway or a comparable section of an area over which a passenger, in particular a wheelchair user, can move away from and/or towards the vehicle.

If the processor does not detect such a path section that leads to and/or away from the detected entry/exit area in step 301 of the method, the processor assesses the detected entry/exit area as unsuitable and rejects the entry/exit area and the corresponding stopping position and continues the method 100 with step 105 of the method, in that the processor searches for a further entry/exit area. For this purpose, the processor can drive the vehicle to a further entry/exit area by generating and issuing suitable control signals to a corresponding control device of the vehicle in order to receive new environment signals. For example, the processor can also cause a further reception of further environment signals by a further actuation of the corresponding environment sensors. For example, the processor can also re-evaluate already received environment signals to detect a further entry/exit area.

If the processor detects a path section connected to the entry/exit area in step 301 of the method, the processor checks this path section in the following step 303 of the method as to whether the detected path section can be traversed independently by a wheelchair user.

The traversability of the path section for a wheelchair user can be determined according to criteria that can be compared, such as the traversability of the entry/exit area according to step 111 of the method. For example, a path section may also have a minimum width of more than 150 cm in order to be rated as traversable by a wheelchair user. In order to check the traversability of the path section, limit values corresponding to various characteristics of the path section affecting the traversability of the path section may be implemented in a database or in the processor or in a computer program. In order to assess the traversability of a detected path section, the processor can determine the properties of the detected path section and compare the properties with the stored limit values.

If the check by the processor according to step 303 of the method shows that the path section is not suitable for independent traversal by a wheelchair user, the processor discards the entry/exit area and the respective stopping position and continues the method 100 with step 105 in that the processor seeks a further entry/exit area. For this purpose, the processor can drive the vehicle to a further entry/exit by generating and issuing suitable control signals to a corresponding control device of the vehicle in order to receive new environment signals. For example, the processor can also cause further reception of further environment signals by a further actuation of the corresponding environment sensors. For example, the processor can also re-evaluate already received environment signals to detect a further entry/exit area.

If there is a positive result of the check carried out by the processor according to step 303 of the method, in a subsequent step 305 of the method the processor recognizes that the path section is independently traversable by a wheelchair user.

In the embodiment of FIG. 3, in the following step 115 of the method the processor determines the stopping position and concludes the procedure with the execution of step 117 of the method as described in FIG. 1, in that the processor generates the control signals to drive the vehicle into the stopping position at least partly automatically.

In the described embodiment, the processor performs step 301 of the method only after performing step 105 of the method. The processor can perform steps 105 and 301 of the method in a different chronological sequence. Also, the processor can perform steps 107, 111 and 303 of the method in any chronological sequence that may differ from the chronological sequence in this embodiment. For example, the processor can first detect a path section and check the traversability of the path section and only then detect an entry-exit area connected with the path section and check the entry-exit area according to steps 107 and 111 of the method.

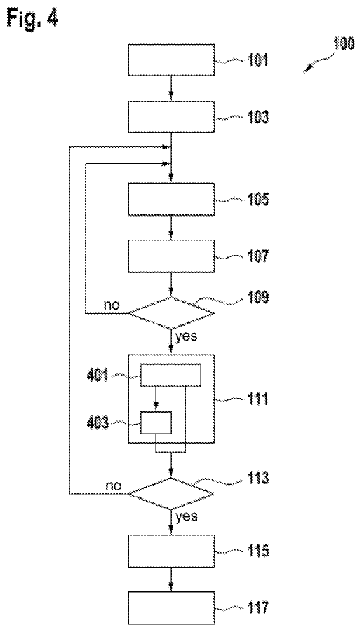

FIG. 4 shows a flow chart of the method 100 for providing control signals for at least partly automated driving of a vehicle into a stopping position according to a further embodiment.

According to a further embodiment, step 111 of the method 100 further comprises the steps:

j) Detecting 401 an object within the entry/exit area;

k) Checking 403 whether the object is an obstacle for the wheelchair user that prevents the wheelchair user from traversing the entry/exit area independently.

In order to determine the independent traversability of the entry/exit area for a wheelchair user, the processor takes into account the presence of an obstacle for wheelchair users in the entry/exit area according to the further embodiment.

For this purpose, after detecting an entry/exit area in accordance with step 105 of the method and evaluating the entry/exit area as suitable in terms of its spatial dimensions according to step 109 of the method, the processor first detects an object in the entry/exit area according to a step 401 of the method.

If the processor does not detect an object in the entry/exit area in step 401 of the method, the processor stops checking for obstacles in the entry/exit area. The processor then continues checking the entry/exit area with regard to the travers ability for a wheelchair user in accordance with step 111 of the method and/or terminates step 111 of the method with a positive or negative result. In accordance with the result of the check from step 111 of the method, in step 113 of the method the processor recognizes the entry/exit area as independently traversable or not independently traversable by a wheelchair user and accordingly continues the method 100 similarly to the embodiment in FIG. 1 with step 115 or step 105 of the method.

If the processor detects an object in the entry/exit area in step 401 of the method, the processor checks whether said object is an obstacle for a wheelchair user according to the next step 403 of the method.

In this context, an obstacle can be any object that cannot be overcome or bypassed by a wheelchair user independently. Said objects can be, for example, stairs, curbsides, railway tracks, road barriers, walls, fences, flowerpots, hydrants, rubbish bins or even just temporarily parked vehicles and similar.

For the check according to step 403 of the method, objects classified as an obstacle can be implemented in a database or processor or computer program. To assess whether a detected object is an obstacle, the processor can compare the corresponding properties of a detected object with the stored objects.

If the processor does not evaluate the detected object as an obstacle for a wheelchair user in step 403 of the method, the processor terminates the check. The processor then continues the check of the entry/exit area with regard to the traversability for a wheelchair user in accordance with step 111 of the method and/or terminates step 111 of the method with a positive or negative result. In accordance with the test result from step 111 of the method, the processor recognizes the entry/exit area for a wheelchair user in step 113 of the method as being independently traversable or not independently traversable and accordingly continues the method 100 similarly to the embodiment in FIG. 1 with step 115 of the method or step 105 of the method.

If the processor assesses the detected object as an obstacle for a wheelchair user in step 403 of the method, in the subsequent step 113 of the method the processor recognizes that the entry/exit area is not independently traversable by the wheelchair user. Subsequently, the processor discards the entry/exit area and the respective stopping position and continues the procedure with step 105 of the method, in that the processor searches for a further entry/exit area. For this purpose, the processor can drive the vehicle to a further entry/exit area by generating and issuing suitable control signals to a corresponding control device of the vehicle in order to receive new environment signals. For example, the processor can also cause a further reception of further environment signals by a further actuation of the corresponding environment sensors. For example, the processor can also re-evaluate already received environment signals to detect a further entry/exit area.

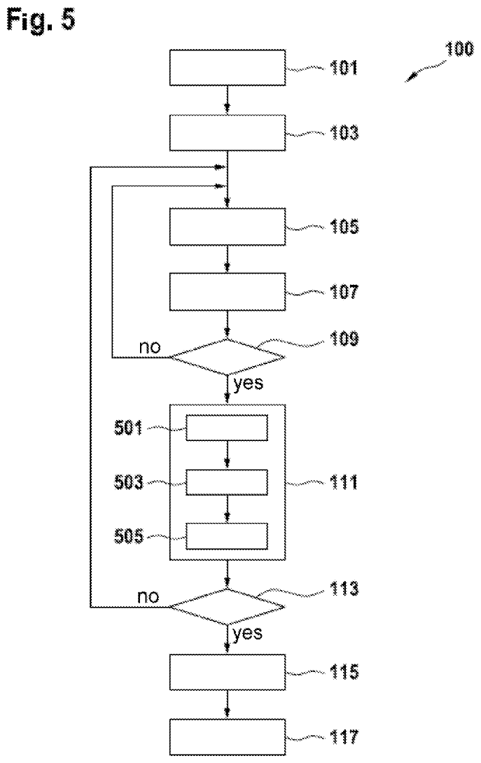

FIG. 5 shows a flow chart of the method 100 for providing control signals for at least partly automated driving of a vehicle into a stopping position according to a further embodiment.

According to a further embodiment, step 111 of the method 100 further includes the steps:

l) Detecting 501 a ground area of the entry/exit area;

m) Determining 503 an inclination of the ground area;

n) Checking 505 on the basis of the inclination whether the ground area is suitable to be traversed by a wheelchair user.

According to the further embodiment, the processor takes into account an inclination of a ground area of the entry/exit area for determination of the independent traversability of an entry/exit area according to step 111 of the method.

For this purpose, after detecting an entry/exit area in accordance with step 105 of the method and rating the entry/exit area as suitable in terms of its spatial dimensions in accordance with step 109 of the method, the processor detects a ground area of the entry/exit area according to a step 501 of the method.

In a subsequent step 503 of the method, the processor determines an inclination of the ground area.

In a subsequent step 505 of the method, the processor checks whether the ground area with the determined inclination can be traversed independently by a wheelchair user.

An inclination of the ground area of the entry/exit area may include a longitudinal and/or a lateral inclination of the ground area relative to a preferred direction. As a preferred direction, for example, the longitudinal direction of the vehicle or the longitudinal direction of the stopping position may be used. For example, an inclination with a gradient of more than 6% may be considered unsuitable for traversal by a wheelchair user.

For checking in accordance with step 505 of the method, corresponding limits may be implemented in a database or in the processor or in a computer program for various inclinations as suitable and/or unsuitable for wheelchair user traversal. In order to assess the traversability of a ground area of a detected entry/exit area, the processor can determine inclinations of a ground area from the detected entry/exit area and compare the inclinations with the stored limit values.

If in step 505 of the method the processor assesses the ground area with the determined inclination as independently traversable by a wheelchair user, the processor terminates the check according to steps 501, 503 and 505 of the method. Subsequently, the processor performs the check of the entry/exit area with regard to traversability for a wheelchair user in accordance with step 111 of the method and/or terminates step 111 of the method with a positive or negative result. In accordance with the test result from step 111 of the method, the processor recognizes the entry/exit area as being independently traversable or not independently traversable by a wheelchair user in step 113 of the method and accordingly continues the method 100 similarly to the embodiment in FIG. 1 with step 115 of the method or step 105 of the method.

If in step 505 of the method the processor assesses the ground area with the determined inclination as not independently traversable for a wheelchair user, in the following step 113 of the method the processor recognizes that the entry/exit area is not independently traversable by the wheelchair users. Subsequently, the processor discards the entry/exit area and the respective stopping position and continues the method with step 105 of the method, in that the processor searches for a further entry/exit area. For this purpose, the processor can drive the vehicle to a further entry/exit area by generating and issuing suitable control signals to a corresponding control device of the vehicle in order to receive new environment signals. For example, the processor can also cause a further reception of further environment signals by a further actuation of the corresponding environment sensors. For example, the processor can also re-evaluate already received environment signals to detect a further entry/exit area.

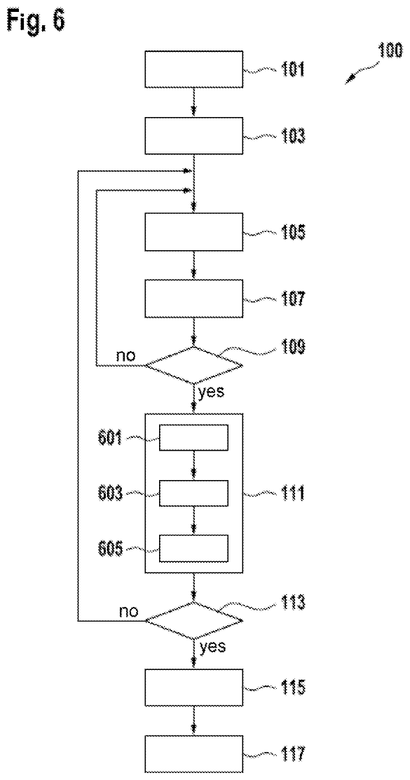

FIG. 6 shows a flow chart of the method 100 for providing control signals for at least partly automated driving of a vehicle into a stopping position according to a further 2 0 embodiment.

According to a further embodiment, step 111 of the method 100 further includes the steps:

o) Detecting 601 a ground area of the entry/exit area;

p) Determining 603 a ground covering of the ground area;

q) Checking 605 on the basis of the ground covering whether the ground area is suitable for traversal by a wheelchair user.

In order to assess the independent traversability of the entry/exit area for a wheelchair user, a ground covering of the ground area of the entry/exit area can also be taken into account.

For this purpose, after detecting an entry/exit area in accordance with step 105 of the method and assessing the entry/exit area as suitable in terms of its spatial dimensions according to step 109 of the method, the processor detects a ground area of an entry/exit area according to a step 601 of the method.

Subsequently, the processor determines a ground covering of the ground area in a subsequent step 603 of the method.

Subsequently, in a subsequent step 605 of the method the processor checks whether the ground area with the determined ground covering is independently traversable by a wheelchair user.

When assessing the ground covering of the ground surface, the rolling properties for a wheelchair can be taken into account. For this purpose, for example, the materials, the strength and flatness of the ground covering can be included. For example, a distinction can be made between concrete surfaces, asphalted road surfaces, cobblestones, paved walkways, forest paths, gravel paths and the like.

In addition, the adhesion that a ground covering can provide to a wheelchair tire can be taken into account. In this context, wetness on the ground surface or a layer of snow, mud, foliage or sand can be included, for example.

For example, a ground covering may be considered unsuitable for independent traversal by a wheelchair user if it is too uneven and prevents the wheelchair tires from rolling, and/or if the flooring does not have sufficient strength and the wheelchair tires sink into the ground, and/or if the ground surface is too smooth to be traversed safely.

For checking in accordance with step 605 of the method, various ground coverings that are suitable and/or unsuitable for traversal by a wheelchair user may be implemented in a database or in the processor or in a computer program. To assess the traversability of a ground area of an entry/exit area, the processor can determine ground coverings of a ground area of a detected entry/exit area and compare said ground coverings with the stored values.

If the processor assesses the ground covering as suitable for independent access by a wheelchair user in step 605 of the method, the processor stops checking the ground covering according to steps 601, 603 and 605 of the method. The processor then carries out the check of the entry/exit area with regard to traversability for a wheelchair user in accordance with step 111 of the method and/or terminates step 111 of the method with a positive or negative result. In accordance with the test result from step 111 of the method, the processor recognizes the entry/exit area as being independently traversable or not independently traversable by a wheelchair user in step 113 of the method and accordingly continues the method 100 similarly to the embodiment in FIG. 1 with step 115 of the method or step 105 of the method.

If the processor assesses the ground covering as unsuitable for independent access by a wheelchair user in step 605 of the method, in the subsequent step 113 of the method the processor recognizes that the entry/exit area is not independently traversable by the wheelchair user. Subsequently, the processor discards the entry/exit area and the respective stopping position and continues the procedure with step 105 of the method, in that the processor searches for a further entry/exit area. For this purpose, the processor may drive the vehicle to a further entry/exit area in order to receive new environment signals by generating and issuing suitable control signals to a corresponding control device of the vehicle. For example, the processor can also cause further reception of further environment signals by a further actuation of the corresponding environment sensors. For example, the processor can also re-evaluate already received environment signals to detect a further entry/exit area.

For at least one of the steps a) to q) of the method described above, in addition to the environment signals the data of a database or a digital map can be taken into account by the processor. The data in the database can, for example, provide information about the location and spatial dimensions of a stopping position and/or an entry/exit area, about corresponding path sections adjacent to the entry/exit area, about permanent obstacles, about inclinations of a ground area of the entry/exit area and/or about ground coverings of the entry/exit area.

Furthermore, on the basis of the data of the database or the digital map, stopping positions can thus be determined in a previously determined target area, so that potential stopping positions can be selected at the time of setting off or while travelling, or stopping positions can be excluded in advance.

For example, in addition to a desired destination the vehicle may be notified of certain requirements for a suitable stopping position at the time of setting off and/or while travelling. For example, the vehicle can also be informed that, for example, a wheelchair user is to be transported as a passenger, and the vehicle automatically detects the respective passenger-related requirements for the stopping position. From the data of the database or the digital map, the vehicle or the processor of the vehicle can then select the stopping positions that lie in a locality that can be determined by the user about the destination and that have an entry/exit area that meets the respective requirements. The vehicle can then determine and accordingly control suitable stopping positions to determine their availability and, if appropriate, can stop the vehicle in one of the stopping positions. This means that a pre-selection of potential stopping positions can be carried out before reaching the destination according to the individual passenger-related requirements on the respective entry/exit area of the stopping position.

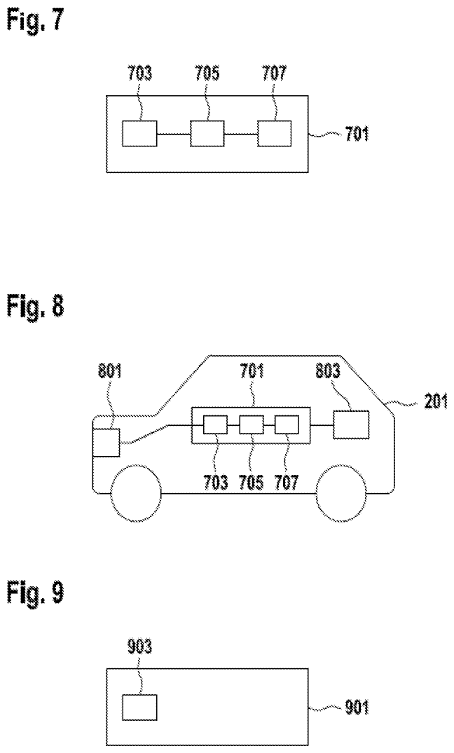

FIG. 7 shows a device 701 that is designed to perform a method 100 for providing control signals for at least partly automated driving of a vehicle into a stopping position.

For example, the device 701 is embodied to carry out all steps of the method 100 according to FIG. 1. The device 701 comprises an input 703 for receiving environment signals representing at least a partial environment of a vehicle. The device also includes a processor 705 for processing the environment signals in order to detect an entry/exit area, in order to check the spatial dimensions of the entry/exit area, in order to recognize the spatial dimensions of the entry/exit area, in order to check the entry/exit area for traversability for a wheelchair user, in order to recognize the traversability of the entry/exit area for a wheelchair user, and to determine a stopping position.

The processor 705 is also embodied to generate control signals for at least partly automated driving of the vehicle into the stopping position.

The device 701 also includes an output 707 for issuing the generated control signals in order to drive the vehicle into the stopping position at least partly automatically. For example, the generated control signals are issued to a control device 803 that is embodied to at least partly control lateral and longitudinal guidance of the vehicle based on the issued control signals.

Instead of the one processor 705, a plurality of processors are also conceivable. The reception of information, data and/or signals can take place via the input 703. The output of signals can take place via the output 707.

FIG. 8 shows a vehicle 201 that includes the device 701 according to FIG. 7, an environment sensor 801, for example a video sensor, and a control device 803.

Environment sensor data of the environment sensor 801 can be provided to the input 703 of the device 701, so that the environment sensor data of the environment sensor 801 can be processed by means of the processor 705 in order to provide a stopping position with an input/exit area with the characteristics described above.

In addition to the one environment sensor 801, the vehicle 201 can comprise additional environment sensors. Also, different types of environment sensors 801 can be fitted on the vehicle 201, so that, for example, video sensors, radar sensors and ultrasonic sensors can be installed together on the vehicle 201. The environment sensors 801 can also be fitted at arbitrary positions on the vehicle 301.

The control signals can be issued via the output 707 to a control device 803 of the vehicle 201 that is embodied to at least partly automatically control lateral and longitudinal guidance of the vehicle 201 on the basis of the control signals.

FIG. 9 shows a machine-readable storage medium 901 on which a computer program 903 is stored. The computer program 903 includes instructions that cause a computer to carry out a method 100 for providing control signals for at least partly automated driving of a vehicle into a stopping position when the computer program 903 is executed by the computer, for example, the device 701 according to FIG. 7.

For example, the vehicle can be a shuttle, a car, a robotaxi or a commercial vehicle.

What is claimed is:

1. A method for providing control signals for least partly automating driving of a vehicle into a stopping position, the method comprising:
receiving vehicle environment signals;
processing the vehicle environment signals, the processing including:
a) detecting an entry/exit area to be used for at least one of boarding and disembarking of a wheelchair user;
b) checking whether the entry/exit area has spatial dimensions required for the at least one of the boarding and the disembarking of the wheelchair user;
c) recognizing that the entry/exit area has the spatial dimensions required for the at least one of the boarding and the disembarking of the wheelchair user;
d) checking whether the entry/exit area is independently traversable by the wheelchair user;
e) recognizing that the entry/exit area is independently traversable by the wheelchair user; and
f) determining a stopping position adjacent to the entry/exit area for stopping the vehicle in response to recognizing that (i) the entry/exit area has the spatial dimensions required for the at least one of the boarding and the disembarking of the wheelchair user and (ii) the entry/exit area is independently traversable by the wheelchair user; and
generating control signals configured to at least partly automate the driving of the vehicle into the stopping position.

2. The method according to claim 1, wherein the control signals are configured to stop the vehicle in the stopping position.

3. The method according to claim 1, the processing the environment signals further including:
g) detecting a path section that leads at least one of away from the entry/exit area and towards the entry/exit area;
h) checking whether the path section is independently traversable by the wheelchair user; and
i) recognizing that the path section is independently traversable by the wheelchair user,
wherein the f) determining the stopping position is performed in response to recognizing that (i) the entry/exit area has the spatial dimensions required for the at least one of the boarding and the disembarking of the wheelchair user, (ii) the entry/exit area is independently traversable by the wheelchair user, and (iii) the path section is independently traversable by the wheelchair user.

4. The method according to claim 1, the d) checking whether the entry/exit area is independently traversable by the wheelchair user further comprising:
j) detecting an object within the entry/exit area; and
k) checking whether the object is an obstacle for the wheelchair user that prevents the wheelchair user from independently traversing the entry/exit area.

5. The method according to claim 4, wherein the obstacle for a wheelchair user is at least one of a stair step, a curbside, a railway track, a path barrier, a wall, a fence, a flower pot, a hydrant, a rubbish bin, a movable object, and a vehicle.

6. The method according to claim 1, the d) checking whether the entry/exit area is independently traversable by the wheelchair user further comprising:
l) detecting a ground area of the entry/exit area;
m) determining an inclination of the ground area; and
n) checking, based on the inclination, whether the ground area is suitable for traversal by the wheelchair user.

7. The method according to claim 1, the d) checking whether the entry/exit area is independently traversable by the wheelchair user further comprising:
o) detecting a ground area of the entry/exit area;
p) determining a ground covering of the ground area; and
q) checking, based on the ground covering, whether the ground area is suitable for traversal by the wheelchair user.

8. The method according to claim 7, wherein the ground covering includes at least one of a concrete surface, an asphalted road surface, cobblestones, a paved walkway, a forest path, a gravel path, a wet layer, a layer of snow, a mud layer, a layer of leaves, and a layer of sand.

9. The method according to claim 1, wherein a digital map of a database is taken into account in the processing the environment signals.

10. The method according to claim 9, the f) determining the stopping position further comprising:
f) determining the stopping position based on the digital map of the database.

11. A device for providing control signals for least partly automating driving of a vehicle into a stopping position, the device configured to:
receive vehicle environment signals;
process the vehicle environment signals to:
a) detect an entry/exit area to be used for at least one of boarding and disembarking of a wheelchair user;
b) check whether the entry/exit area has spatial dimensions required for the at least one of the boarding and the disembarking of the wheelchair user;
c) recognize that the entry/exit area has the spatial dimensions required for the at least one of the boarding and the disembarking of the wheelchair user;
d) check whether the entry/exit area is independently traversable by the wheelchair user;
e) recognize that the entry/exit area is independently traversable by the wheelchair user; and
f) determine a stopping position adjacent to the entry/exit area for stopping the vehicle in response to recognizing that (i) the entry/exit area has the spatial dimensions required for the at least one of the boarding and the disembarking of the wheelchair user and (ii) the entry/exit area is independently traversable by the wheelchair user; and
generate control signals configured to at least partly automate the driving of the vehicle into the stopping position.

12. The device according to claim 11, wherein the vehicle includes the device.

13. The device according to claim 11, wherein the device is configured to execute a computer program to receive the vehicle environment signals, process the vehicle environment signals, and generate the control signals.

14. The device according to claim 11, wherein the computer program is stored on a machine-readable storage medium.
